(19) United States
(12) Patent Application Publication
(10) Pub. No.: US 2026/0319853 A1
(43) Pub. Date: Oct. 15, 2026

(54) Issuing Delegate Credentials For Accessing Target Resources

(71) Applicant: Oracle International Corporation, Redwood Shores, CA (US)

(72) Inventors: Thoulfekar Alrahem, Bend, OR (US); Daniel M. Vogel, Seattle, WA (US); Girish Nagaraja, Sammamish, WA (US)

(73) Assignee: Oracle International Corporation, Redwood Shores, CA (US)

(21) Appl. No.: 19/718,484

(22) Filed: Jun. 24, 2026

Related U.S. Application Data
(63) Continuation of application No. 18/529,558, filed on Dec. 5, 2023.
(63) Continuation of application No. 18/640,885, filed on Apr. 19, 2024.
Application No. 18/640,885 is a continuation-in-part of application No. 18/529,558, filed on Dec. 5, 2023.

(51) Int. Cl. G06F 9/50

(52) U.S. Cl. CPC G06F 9/5027

(57) ABSTRACT

A system provides a delegate credential to access a target resource based on one or more access policies associated with a delegate principal. The system receives a credential request for the delegate credential from a computing entity associated with a recipient principal. The system transmits an approval request to an approval service associated with the target resource for the approval service to approve issuance of the delegate credential to the recipient principal. The system receives an approval confirmation from the approval service and generates the delegate credential responsive to receiving the approval confirmation. The system transmits the delegate credential to a computing entity associated with the recipient principal. The computing entity accesses the target resource by presenting the delegate credential to a resource service associated with the target resource.

### INCORPORATION BY REFERENCE; DISCLAIMER

This application is a continuation of U.S. patent application Ser. No. 18/529,558, filed Dec. 5, 2023. This application is also a continuation of U.S. patent application Ser. No. 18/640,885, filed on Apr. 19, 2024, which is a continuation in part of U.S. patent application Ser. No. 18/529,558, filed on Dec. 5, 2023. U.S. patent application Ser. Nos. 18/529,558 and Ser. No. 18/640,885 are hereby incorporated by reference in their entirety. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to accessing target resources on cloud computing networks. More particularly, the present disclosure relates to issuing delegate credentials that can be used by a recipient to access the target resources.

### BACKGROUND

Access to target resources on a cloud computing network may be based at least in part on one or more access policies that are managed by an identity access management (IAM) system. The principal presents a credential along with a requested action to be performed with respect to the target resource. The credential associates the principal with an identity in the IAM system. The IAM system includes one or more access policies associated with the identity of the principal. The one or more access policies may define permissions or actions that are allowed or denied, for example, with respect to the target resource itself or a compartment where the target resource is located. If the one or more access policies include a permission that encompasses the requested action, the principal is granted access to the target resource, enabling the principal to perform the requested action. If the permissions in the one or more access policies do not encompass the requested action, access is denied, and the requested action rejected, thereby ensuring that actions performed with respect to the target resource align with the permissions defined by the access policies.

The content of this background section should not be construed as prior art merely by virtue of its presence in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIGS. 6A and 6B illustrates features of an example system in accordance with one or more embodiments;

FIG. 7A shows a diagram that illustrates example operations pertaining to pre-approval of delegate principals;

FIG. 7B shows a diagram that illustrates example operations pertaining to approval and issuance of a delegate credential to access a target resource based on an access policy associated with a delegate principal;

FIG. 7C shows a diagram that illustrates example operations pertaining to validating an access request to access a target resource based on an access policy associated with a delegate credential; and

FIG. 8 is a flowchart that illustrates example operations pertaining to generating and issuing a delegate credential in response to a credential request associated with a recipient principal.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. DEFINITIONS
3. CLOUD COMPUTING TECHNOLOGY
4. COMPUTER SYSTEM
5. ARCHITECTURAL OVERVIEW
6. PRE-APPROVAL, APPROVAL, AND VALIDATION OPERATIONS
7. ISSUING DELEGATE CREDENTIALS TO RECIPIENT PRINCIPALS
8. MISCELLANEOUS; EXTENSIONS

### 1. General Overview

One or more embodiments issue a delegate credential to access a target resource based on one or more access policies associated with an identity of a delegate principal in an IAM system. The delegate credential is issued to a recipient principal to enable a computing entity associated with the recipient principal to access the target resource based on the one or more access policies associated with the delegate principal. The IAM system does not include an access policy associated with the identity of the recipient principal that would allow a computing entity associated with the recipient principal to access the target resource. Instead, the computing entity associated with the recipient principal accesses the target resource based on the identity representation of the delegate principal. To access the target resource, the computing entity associated with the recipient principal presents the delegate credential and an access request to a resource service associated with the target resource. The resource service utilizes the delegate credential to identify one or more access policies in the IAM system associated with the delegate principal corresponding to the delegate credential. The resource service validates that the one or more access policies include permissions that encompasses the requested action, and upon successful validation, the resource service authorizes the computing entity to access the target resource based on the one or more access policies associated with the delegate principal.

In one example, a cloud provider may provide cloud computing services to one or more tenants, such as a cloud provider infrastructure and/or one or more target services located in the cloud provider infrastructure. The tenants may own target resources that are located in the cloud provider infrastructure. Access to the target resources may be restricted based on access policies that are associated with particular identities in an IAM system. Some computing entities, or users of such computing entities, may lack an identity in the IAM system and, thus, are unable to access the target resources based on an access policy in the IAM system. Additionally, or in the alternative, the IAM system may include an identity representing a computing entity, and the one or more access policies associated with the identity may lack one or more permissions to access the target resources.

To enable such computing entities, or users of such computing entities, to access target resources, the IAM system may be configured with one or more delegate principals. Each delegate principal includes an identity representation that is associated with one or more access policies that allow for access to one or more target resources. The delegate principal is delegable to a recipient principal that represents an identity of a computing entity, or a user of the computing entity, to which the delegate principal is delegated. The delegation of the delegate principal to the recipient principal is represented by a delegate credential issued to the recipient principal. The computing entity associated with the recipient principal may access a target resource based on the identity representation of the delegate principal by presenting the delegate credential and an access request to a resource service associated with the target resource. The resource service utilizes the delegate credential to identity one or more access policies in the IAM system associated with the delegate principal, and if the one or more access policies associated with the delegate principal allow for access to the target resource, the resource service authorizes the computing entity to access the target resource.

The access policies associated with the delegate principals may include various types of permissions. In one example, one or more permissions corresponding to an access policy may include limitations on the types of operations that can be performed with respect to a target resource. Additionally, or in the alternative, one or more permissions corresponding to an access policy may include time-based or session-based limitations on access to a target resource. A particular delegate principal may be delegated to a recipient principal based on the particular permissions for which the recipient principal is approved. Thus, access to the target resource may be limited to the particular operations, time period, and/or session, for example, on a case-by-case basis, according to the particular delegate principal that is delegated to the recipient principal.

In one example, a delegate principal allows the system to grant access to a recipient principal in a transparent and controlled way such that only the recipient principal is granted permission but the recipient principal cannot directly perform the authorized actions unless using the delegate principal. In one example, a delegate principal allows the system to distinguish between (a) a computing entity executing an operation on a target resource based on an access policy associated with the delegate principal that has been delegated to the recipient principal and (b) the computing entity executing an operation on a target resource based on an access policy directly associated with the recipient principal (as opposed to a delegate principal). In one example, a delegate principal cannot stand on its own and is not usable as an independent principal. Additionally, or alternatively, in one example, the delegate principal must be associated with a recipient principal in order for the computing entity to execute an operation upon a target resource based on an access policy associated with the delegate principal.

One or more embodiments described in this Specification and/or recited in the claims may not be included in this General Overview section.

### 2. Definitions

As used herein, the term “principal” refers to an identity of an entity that interacts with and accesses cloud resources or services. A principal may be utilized by an IAM system to uniquely identify and/or authenticate the identity of the entity represented by the principal. The principal may be associated with one or more access policies that define what actions associated with the principal are to be allowed or denied by the IAM system. As examples, the entity associated with a principal may include a user, a device, a resource, or a service. In one example, the term “principal” may include recipient principals and/or delegate principals. A principal may include a user principal, a resource principal, a service principal, a group principal, a device principal, a role principal, or a group principal. A user principal may represent an identity of an individual user. A resource principal may represent an identity of a computing entity or resource. A service principal may represent an identity of application or a service. A device principal may represent an identity of a particular computing device. A role principal may represent an identity of a specific role or set of responsibilities within an organization or system. A group principal may represent an identity of a group of users or other principals. A group principal may be used to uniquely identify and/or authenticate the group. A group principal may be used to simplify access control by providing access control policies that are to be applied to a group of users or other principles, rather than individual users or other principals.

As used herein, the term “recipient principal” refers to a principal to which one or more access policies associated with a delegate principal are delegated. By delegating the one or more access policies associated with the delegate principal to the recipient principal, the recipient principal may access a target resource based on the one or more access policies associated with the delegate principal. A recipient principal may include a user principal, a resource principal, a service principal, a group principal, a device principal, a role principal, or a group principal. A recipient principal may be utilized by an IAM system to uniquely identify and/or authenticate the identity represented by the recipient principal. As examples, a recipient principal may be associated with a tenant, a cloud operator, or a cloud provider. In one example, a recipient principal may have no identity representation whatsoever within the IAM system, and access to a target resource may be based on one or more access policies associated with a delegate principal. Additionally, or in the alternative, a recipient principal may have an identity representation within the IAM system, but may lack an access policy for accessing a target resource or for performing a desired action with respect to the target resource. Additionally, or in the alternative, a recipient principal may have an identity representation elsewhere, such as in a separate IAM system.

As used herein, the term “recipient credential” refers to a credential, issued to a recipient principal or to a computing entity associated with a recipient principal, that identifies the recipient principal. A recipient credential may include a recipient principal-identifier that uniquely identifies a recipient principal in the IAM system.

As used herein the term “delegate principal” refers to an identity representation that is delegated to an entity identified by or associated with a recipient principal to enable the entity to access a target resource based on one or more access policies in an IAM system associated with the delegate principal. In one example, a delegate principal may be attached to a particular recipient principal for which the delegate principal has been generated such that the one or more access policies associated with the delegate principal may be utilized only by the recipient principal to which the one or more access policies associated with a delegate principal are delegated.

As used herein, the term “delegate credential” refers to a credential, issued to a recipient principal or to a computing entity associated with a recipient principal, that identifies a delegate principal associated with one or more access policies in an IAM system that are delegated to the recipient principal to enable the recipient principal or an entity associated with the recipient principal to access a target resource based on the one or more access policies associated with the delegate principal. A delegate credential may include a delegate principal-identifier that uniquely identifies a delegate principal in the IAM system. The delegate principal-identifier can be associated with one or more access policies corresponding to one or more target resource.

In one example, an access request may be accompanied by a recipient credential and a delegate credential. The recipient credential may include a public key that corresponds to a private key associated with the recipient principal. The access request may be digitally signed using the private key. By digitally-signing the access request, the system can validate that the access request is being made by the specific recipient principal that holds the private key. Additionally, or alternatively, the delegate credential may be digitally signed using the private key. By digitally signing the delegate credential, the system can validate that the delegate credential is being used by the specific recipient principal that holds the private key. Additionally, or alternatively, in one example, the public key that corresponds to the private key associated with the recipient principal may be included in the delegate credential. Additionally, or in the alternative, a recipient credential and a delegate credential may each include a recipient principal-identifier that uniquely identifies the recipient principal. The recipient principal-identifier in the delegate credential can be validated against the recipient principal-identifier in the recipient credential. This ensures the delegate credential can be used only by the specific recipient principal identified by the recipient principal-identifier.

As used herein, the term “access policy” refers to a set of one or more rules, permissions, or configurations that define what actions are allowed or denied for a particular principal with respect to particular resources within a computing network, such as a virtual cloud network. An access policy may be managed by an IAM system. The IAM System may include one or more access policies associated with a particular principal. Additionally, or in the alternative, the IAM system may include one or more access policies corresponding to a particular resource. An access policy may be associated with one or more compartments of a virtual cloud network. Additionally, or in the alternative, an access policy may be associated with one or more logical containers of a particular compartment.

As used herein, the term “compartment” refers to a set of one or more logical containers utilized to organize and segregate resources, services and/or permissions of a cloud computing environment.

As used herein, the term “logical container” refers to a virtual structure used to organize and manage cloud resources, services, or data.

As used herein, the term “target resource” refers to a cloud resource that may be accessed based on one or more access policies in an IAM system. As examples, a target resource may include one or more of: virtual machines, databases, services, data storage resources, containers, compartments, or networking resources.

As used herein, the term “tenant” refers to an entity that receives cloud computing services provided by a cloud provider.

As used herein, the term “cloud provider” or “service provider” refers to a provider of cloud computing services, such as an Infrastructure as a Service and/or one or more target services located on a cloud provider infrastructure.

As used herein, the term “cloud operator” refers to an entity that maintains cloud infrastructure. A cloud operator may perform services on behalf of a cloud provider, such as provisioning, configuring, troubleshooting, debugging, maintaining, or managing cloud resources and related infrastructure. A cloud operator and a cloud provider may be different entities or the same entities.

As used herein, the term “customer” may refer to a tenant, or an entity that receives services from a tenant.

As used herein, the term “on-premises network” refers to a network infrastructure or device that is located and operated within a physical premises or data center of a tenant.

As used herein, the term “multi-cloud environment” refers to a cloud computing strategy in which an organization uses and integrates services and resources from multiple cloud providers. In a multi-cloud environment, an organization may simultaneously utilize the infrastructure, platform, or software services of two or more cloud providers, rather than relying on a single cloud provider for all its cloud needs. Additionally, or in the alternative, in a multi-cloud environment, a first cloud provider may be a customer or a client with respect to a second cloud provider.

As used herein, the term “network entity” refers to a device, component, or element within a computer network and/or cloud infrastructure. A network entity may be implemented in hardware and/or software.

As used herein, the term “asymmetric key pair” refers to a public key and a private key that are associated with one another, such that a digital signature or an encryption generated using the private key may be validated or decrypted using the public key.

As used herein, the term “digital certificate” refers to a digitally signed electronic document that binds a public key to the identity of an entity or certificate holder. The entity or certificate holder may hold a private key corresponding to the public key. The public key may be included in or associated with the digital certificate. The digital certificate may be validated by matching the public key to the private key through the use of cryptography. A digital certificate may conform to International Telecommunication Union standard X.509. A digital certificate may include an issuer's name, a certificate holder's name, a public key, issuer (CA) information, and expiration date. Digital certificates may be used in various security protocols, such as SSL/TLS, to establish the identity and authenticity of the communicating parties and facilitate secure communication.

### 3. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In some cases, a cloud computing model will involve the participation of a cloud provider. The cloud provider may, but need not be, a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

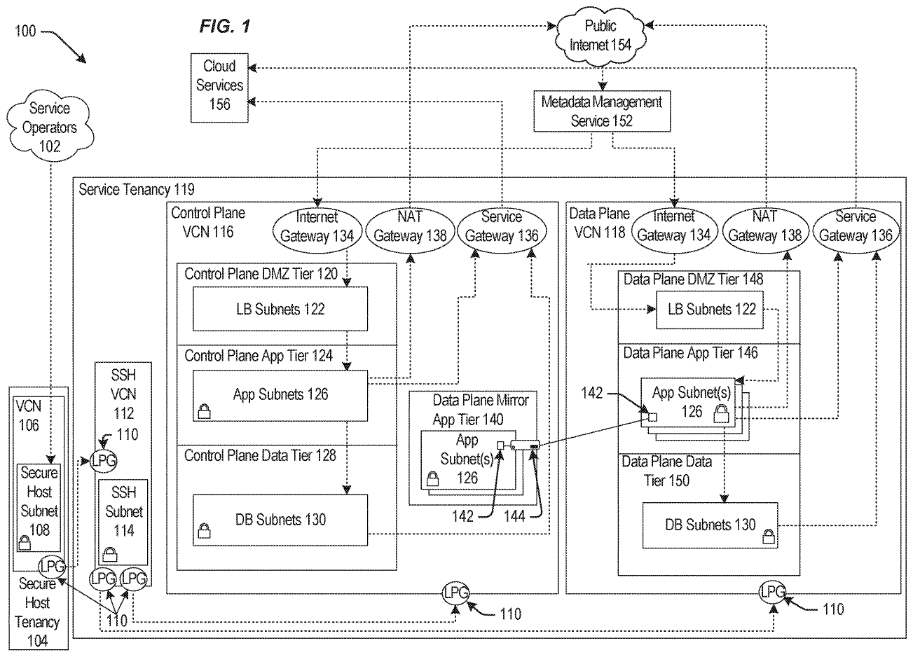

FIG. 1 is a block diagram illustrating an example pattern of an IaaS architecture 100, according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116, and the app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way: the service gateway 136 can make API calls to cloud services 156, and cloud services 156 can send requested data to the service gateway 136. But, cloud services 156 may not initiate API calls to the service gateway 136.

In some examples, the secure host tenancy 104 can be directly connected to the service tenancy 119, which may be otherwise isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response to this determination, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118, both of which may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154, which may not have a desired level of threat prevention, for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119, which may be isolated from public Internet 154.

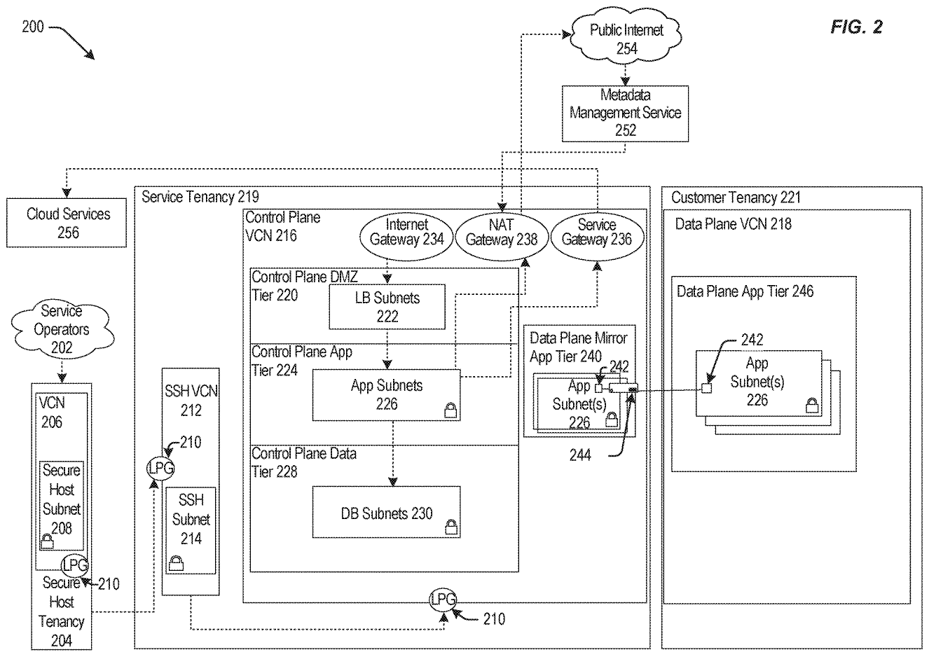

FIG. 2 is a block diagram illustrating another example pattern of an IaaS architecture 200, according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216, and the app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique, compute instance 244 that is contained in the service tenancy 219. Each compute instance 244 may allow communication between the control plane VCN 216, contained in the service tenancy 219, and the data plane VCN 218 that is contained in the customer tenancy 221. The compute instance 244 may allow resources, that are provisioned in the control plane VCN 216 that is contained in the service tenancy 219, to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment, or other usage of resources, of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1,” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

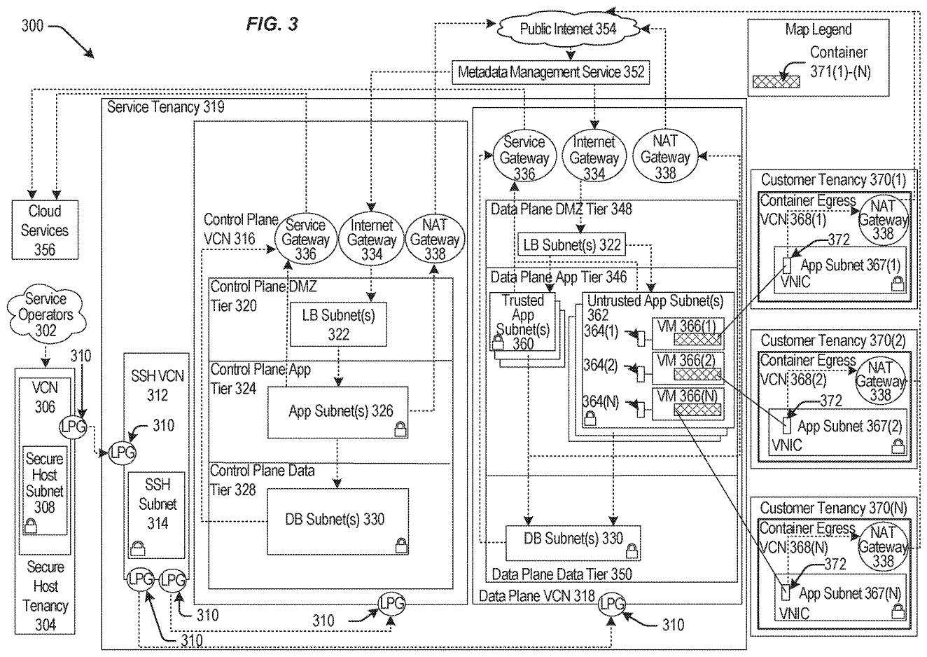

FIG. 3 is a block diagram illustrating another example pattern of an IaaS architecture 300, according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360 and untrusted app subnet(s) 362 of the data plane app tier 346 and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code, where the containers 381(1)-(N) may be contained in at least the VM 366(1)-(N) that are contained in the untrusted app subnet(s) 362), which may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

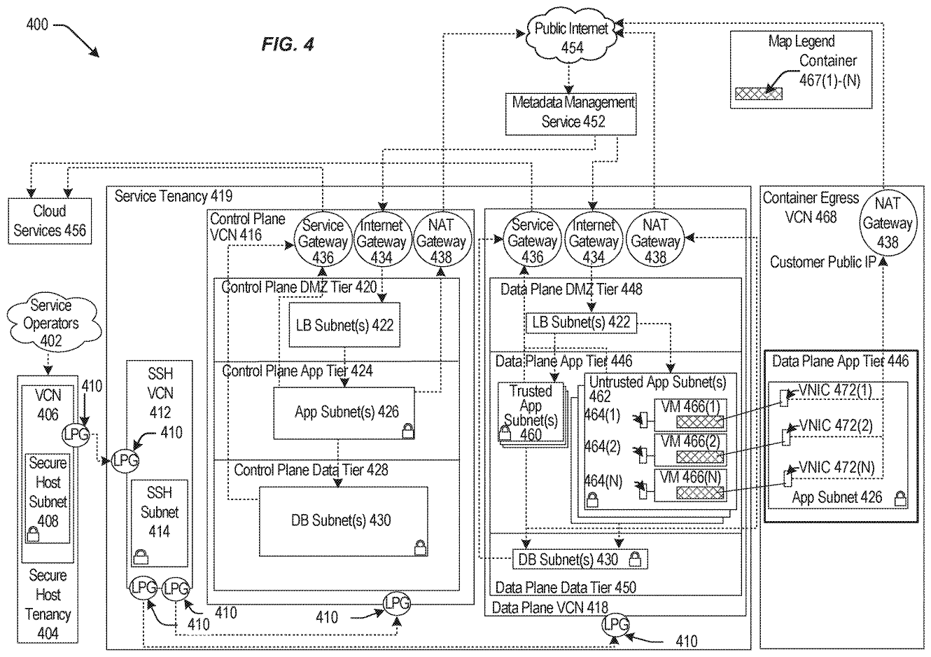

FIG. 4 is a block diagram illustrating another example pattern of an IaaS architecture 400, according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N), and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real-time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that requests a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, 400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 4. Computer System

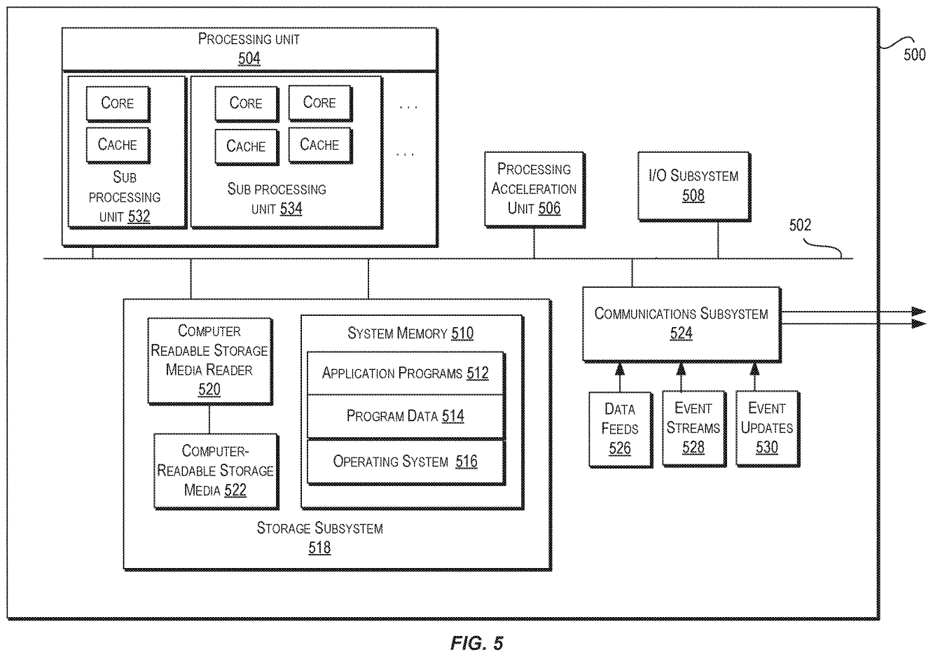

FIG. 5 illustrates an example computer system 500, in which various embodiments may be implemented. The system 500 may be used to implement any of the computer systems described above. As shown in FIG. 5, computer system 500 includes a processing unit 504 that communicates with a number of peripheral subsystems via a bus subsystem 502. These peripheral subsystems may include a processing acceleration unit 506, an I/O subsystem 508, a storage subsystem 518 and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which can be implemented as one or more integrated circuits (e.g., a conventional microprocessor or microcontroller), controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some or all of the program code to be executed can be resident in processing unit 504 and/or in storage subsystem 518. Through suitable programming, processing unit 504 can provide various functionalities described above. Computer system 500 may additionally include a processing acceleration unit 506, which can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various different kinds of programs may be loaded into system memory 510 including but not limited to client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 510 may include a basic input/output system (BIOS) containing basic routines that help to transfer information between elements within computer system 500, such as during start-up.

Computer-readable storage media 522 may represent remote, local, fixed, and/or removable storage devices plus storage media for temporarily and/or more permanently containing, storing, computer-readable information for use by computer system 500 including instructions executable by processing unit 504 of computer system 500.

Computer-readable storage media 522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments communications subsystem 524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 524 may also be configured to receive data in the form of continuous data streams, which may include event streams 528 of real-time events and/or event updates 530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended only as a specific example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 5. Architectural Overview

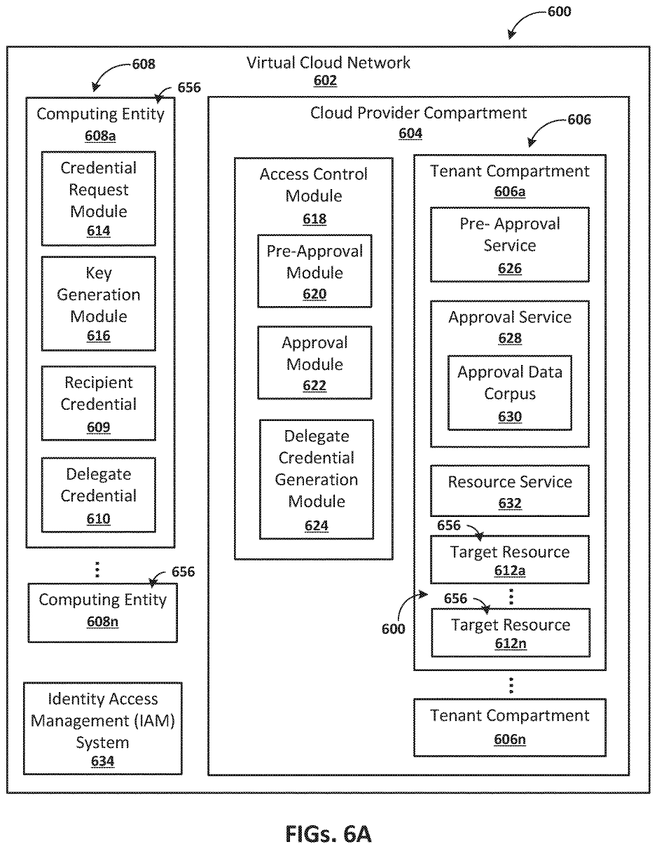

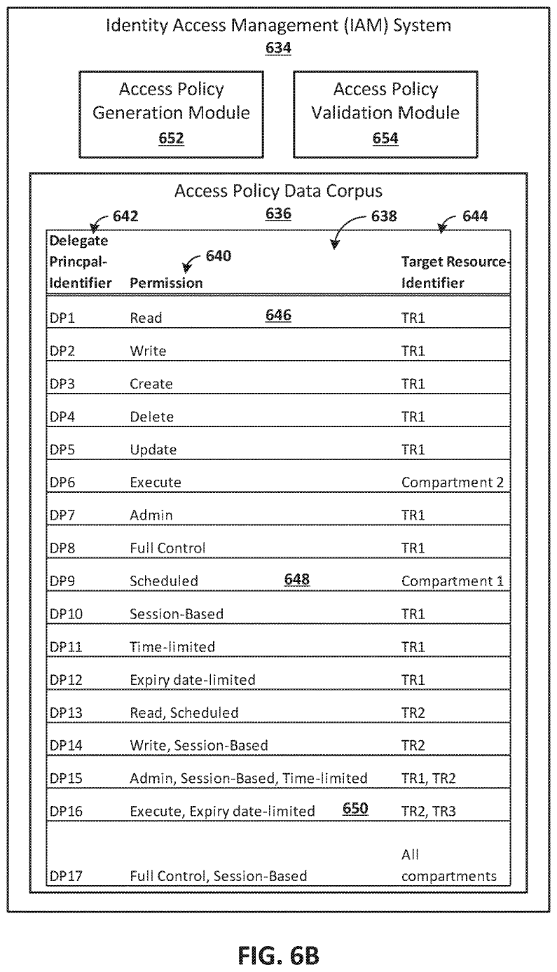

FIGS. 6A and 6B illustrate one example of a system 600 in accordance with one or more embodiments. The system 600 described with reference to FIGS. 6A and 6B may perform operations associated with approving and/or pre-approving recipient principals to obtain delegate credentials. Additionally, the system 600 may perform operations associated with validating delegate credentials and accessing target resources based on access policies associated with delegate principals.

As shown in FIG. 6A, the system 600 may include a virtual cloud network 602. The virtual cloud network may include a cloud provider compartment 604 and one or more tenant compartments 606, such as tenant compartment 606a and tenant compartment 606n. The cloud provider compartment 604 may encompass one or more tenant compartments 606. Additionally, or in the alternative, the cloud provider compartment 604 and one or more tenant compartments 606 may respectively represent separate portions of the virtual cloud network 602.

The virtual cloud network 602 may additionally include one or more computing entities 608, such as computing entity 608a and computing entity 608n. Additionally, or in the alternative, the system 600 may include one or more computing entities 608 that are located external to the virtual cloud network 602. In one example, virtual cloud network 602 may represent a portion of a multi-could network. For example, a first virtual cloud network (e.g., virtual cloud network 602) may be associated with a first cloud provider, and a second virtual cloud network (not shown) may be associated with a second cloud provider. The first virtual cloud network (e.g., virtual cloud network 602) may include one or more target resources 612, and the second virtual cloud network (not shown) may include one or more computing entities 608 that may access the one or more target resources 612. Additionally, or in the alternative, the one or more computing entities 608 may be located on an on-premises network.

The one or more computing entities 608 may include a recipient credential 609 that identifies a recipient principal. A computing entity 608 may include one or more recipient credentials 609. The one or more computing entities 608 may obtain a delegate credential 610 that may be utilized to access one or more target resources 612. The delegate credential 610 may be associated with a particular recipient principal. The particular recipient principal associated with the delegate credential may be identified by a recipient credential 609. A computing entity 608 may obtain a plurality of delegate credentials 610. Each delegate credential 610 may be associated with a particular recipient principal. In one example, each delegate credential 610 may be utilized to access a different set of one or more target resources 612. Additionally, or in the alternative, a computing entity 608 may obtain a new delegate credential for each particular instance or session of access to a target resource 612. As shown in FIG. 6A, one or more target resources 612 may be located within a tenant compartment 606. Additionally, or in the alternative, one or more target resources 612 may be located outside of a tenant compartment 606, such as in a different portion of the virtual cloud network 602.

A computing entity 608 may include a credential request module 614. A credential request module 614 may perform operations associated with requesting pre-approval to obtain a delegate credential and/or operations associated with requesting a delegate credential. A credential request module 614 may represent a portion of a computing entity 608 and/or a credential request module may be a separate component of the system 600, such as a separate component of the virtual cloud network 602, that performs operations on behalf of one or more computing entities 608.

A computing entity 608 may include a key generation module 616. A key generation module 616 may perform operations associated with generating key pairs for use in validating delegate credentials. In one example, a key generation module 616 may generate a private key and a public key. The public key may be incorporated into a recipient credential 609 and/or a delegate credential 610. Additionally, or alternatively, the public key may be included in a pre-approval request and/or an approval request to access a target resource. When the computing entity 608 presents the delegate credential 610 in connection with an access request to access the target resource 612, the computing entity may include a digital signature generated by the private key corresponding to the public key. In one example, the access request may be digitally signed using the private key. By digitally-signing the access request, the system can validate that the access request is being made by the specific recipient principal that holds the private key. Additionally, or alternatively, the delegate credential may be digitally signed using the private key. By digitally signing the delegate credential, the system can validate that the delegate credential is being used by the specific recipient principal that holds the private key. Additionally, or in the alternative, a recipient credential 609 and a delegate credential 610 may include a recipient principal-identifier that uniquely identifies the recipient principal. The recipient principal-identifier in the recipient credential 609 can be validated against the recipient principal-identifier in the delegate credential 610 to ensures the delegate credential is being used by the specific recipient principal identified by the recipient principal-identifier. When the digital signature and the recipient-principal identifier are successfully validated, access to the target resource 612 may be granted based on the delegate credential 610.

The virtual cloud network 602 may include at least one access control module 618. An access control module 618 may perform operations associated with approving and/or pre-approving requests for delegate credentials. Additionally, or in the alternative, an access control module 618 may perform operations associated with generating and/or issuing delegate credentials. In one example, an access control module 618 may include a pre-approval module 620, an approval module 622, and a delegate credential generation module 624. The pre-approval module 620 may perform operations associated with obtaining pre-approval for a recipient principal to be pre-approved to obtain a delegate credential. The approval module 622 may perform operations associated with approving requests for a recipient principal to be issued a delegate credential. The delegate credential generation module 624 may perform operations associated with generating and issuing delegate credentials.

In one example, an access control module 618 may be located in a cloud provider compartment 604. Additionally, or in the alternative, an access control module may be located in a tenant compartment 606 and/or in a different portion of the virtual cloud network 602. In one example, an access control module 618 may perform operations pertaining to a set of one or more tenant compartments 606 and/or a set of one or more target resources 612. Additionally, or in the alternative, the system 600 may include a plurality of access control modules 618, and each access control module 618 may respectively perform operations pertaining to a particular subset of one or more tenant compartments 606 and/or a particular subset of one or more target resources 612.

A tenant compartment 606 may include at least one pre-approval service 626. A pre-approval service 626 may perform operations associated with pre-approving issuance of a delegate credential 610 for accessing one or more target resources 612 in the tenant compartment 606. Additionally, or in the alternative, a tenant compartment 606 may include at least one approval service 628. An approval service 628 may perform operations associated with approving requests for a delegate credential 610 to access one or more target resources 612 in the tenant compartment 606. In one example, the tenant compartment 606 may include an approval data corpus 630. The approval data corpus 630 may include information utilized for approving and/or pre-approving issuance of delegate credentials. Additionally, or in the alternative, the approval data corpus 630 may include information pertaining to request for delegate credentials 610 that have been approved and/or pre-approved. In one example, each tenant compartment 606 of the virtual cloud network 602 may include an approval service 628 and/or a pre-approval service 626. Additionally, or in the alternative, a tenant compartment 606 may include a plurality of approval services 626 and/or pre-approval services 628 corresponding respectively to different sets of one or more target resources 612.

A tenant compartment 606 may include at least one resource service 632. A resource service 632 may perform operations associated with receiving access requests from computing entities 608 and granting access to target resources 612. The access requests may be accompanied by a delegate credential 610. The resource service 632 may validate delegate credentials 610 and grant access to target resources responsive to successfully validating delegate credentials 610. In one example, each tenant compartment 606 of the virtual cloud network 602 may include at least one resource service 632. Additionally, or in the alternative, a tenant compartment 606 may include separate resource service 632 corresponding respectively to different sets of one or more target resources 612.

The virtual cloud network may include an IAM system 634. The IAM system 634 may manage and store access policies associated with various principals. The principles associated with access policies in the IAM system may include one or more delegate principles and/or one or more recipient principles. The IAM system includes one or more access policies associated with the identity of the principal. The access policies may define permissions or actions that are allowed or denied, for example, with respect to one or more target resources 612 and/or with respect to one or more compartments of the virtual cloud network 602, such as a compartment where the particular target resource 612.

Referring to FIG. 6B, an example IAM system 634 is further described. As shown in FIG. 6B, an IAM system may include an access policy data corpus 636. The access policy data corpus 636 may store one or more access policies 638. Each access policy 638 in the access policy data corpus 636 may include one or more permissions 640. The one or more permissions may respectively identify characteristics and/or conditions of access to one or more compartments and/or target resources. In one example, the one or more permissions may include at least one action permission. An action permission may identify one or more types of access that are allowed or denied. An action permission may include at least one of: read, write, create, delete, update, or execute. In one example, the one or more permissions may include at least one temporal permission. A temporal permission may include at least one time-based condition on one or more types of access. A temporal permission may include at least one of: scheduled, session-based, time-duration, expiry date-limited. A schedule permission may allow access according to a schedule. A session-based permission may allow access during a particular session, such as a current session. A time-duration permission may allow access for a specified duration of time. An expiry date-permission may allow access until an expiry date.

Each access policy 638 may include at least one delegate principal-identifier 642. A delegate principal-identifier 642 may associate one or more delegate principals with the access policy 638. Additionally, or in the alternative, an access policy 638 may include at least one recipient principal-identifier that associates one or more recipient principles with the access policy. Each access policy 638 may further include at least one target resource-identifier 644. A target resource-identifier 644 may associate one or more target resources 612 with the access policy 638. In one example, an access policy 638 may include at least one permission 640, at least one delegate principal-identifier 642, and at least one target resource-identifier 644. An access policy may An access policy 638 may indicate that a delegate principal, identified by a delegate principal-identifier 642, has at least one permission 640 that defines one or more characteristics or conditions of access to at least one target resource 612, identified by a target resource-identifier 644.

In one example, as shown in FIG. 6B, a first access policy 646 may provide a first delegate principal, identified by delegate principal-identifier “DP1,” with “Read” access to a first target resource 612, identified by target resource-identifier “TR1.” Additionally, or in the alternative, a second access policy 648 may provide a second delegate principal, identified by delegate principal-identifier “DP9,” with “Scheduled” access to a set of one or more target resources 612 located within a compartment, identified by target resource-identifier “Compartment 1.” Additionally, or in the alternative, a third access policy 650 may provide a third delegate principal, identified by delegate principal-identifier “DP16,” with “Expiry date-limited” access to perform “Execute” operations on a second target resource 612, identified by target resource-identifier “TR2,” and a third target resource 612, identified by target resource-identifier “TR3.”

Referring further to FIG. 6B, an IAM system 634 may include an access policy generation module 652 and/or an access policy validation module 654. The access policy generation module 652 may perform operations associated with generating access policies 638. In one example, the access policy generation module 652 may generate access policy 638 corresponding with a delegate credential when the access policy data corpus 636 does not already include an access policy 638 corresponding to the characteristics and/or conditions of access to a target resource 612 for which a delegate credential 610 is being approved, pre-approved, and/or issued. The access policy validation module 654 may determine whether the access policy data corpus 636 includes an access policy 638 corresponding to the characteristics and/or conditions of access to a target resource 612 that is being requested.

In one example, the access policy validation module 654 may compare information from a pre-approval requisition and/or an approval request to information in the access policy data corpus 636 to determine whether an access policy 638 in the access policy data corpus 636 corresponds to the information from the pre-approval requisition and/or the approval request. Additionally, or in the alternative, the access policy validation module 654 may obtain information from the access policy data corpus 636 for comparison to information from a pre-approval requisition and/or an approval request, for example, to determine whether an access policy 638 in the access policy data corpus 636 corresponds to the information from the pre-approval requisition and/or the approval request. When a pre-approval requisition and/or an approval request is approved, and information from the pre-approval requisition and/or approval request does not correspond to an access policy 638 in the access policy data corpus 636, the access policy validation module 654 may prompt the access policy generation module 652 to generate a new access policy 638. The access policy validation module 654 may be associated with a resource principal in the IAM system, and the resource principal may be associated with an access policy in the IAM system that has permissions to generate the new access policy 638.

In one example, the access policy validation module 654 may compare information from a delegate credential 610 and/or information from an access request accompanying a delegate credential 610 to information in the access policy data corpus 636 to determine whether an access policy 638 in the data corpus corresponds to the information from the delegate credential 610 and/or access request. Additionally, or in the alternative, the access policy validation module 654 may obtain information from the access policy data corpus 636 for comparison to information from the delegate credential 610 and/or access request, for example, to determine whether an access policy 638 in the data corpus corresponds to the information from the delegate credential 610 and/or access request. When information from the delegate credential 610 and/or access request matches an access policy 638 in the access policy data corpus 636, the access policy validation module 654 may prompt the resource service 632 to grant the requested access in accordance with the access policy 638.

Referring further to FIG. 6A, the system 600 may include a plurality of network entities 656. The plurality of network entities 656 may include a plurality of computing entities 608 and/or a plurality of target resources 612. The network entities 656 may be located throughout one or more virtual cloud networks 602. A network entity 656 may reside on a substrate network, an overlay network, or a network interface. A network entity 656 may be implemented in hardware and/or software. A network entity may include a node, a host, an agent, a service, a component, an endpoint, or other element. The plurality of network entities 656 may include one or more substrate entities, one or more interface entities, and/or one or more overlay entities.

As used herein, the term “substrate entity” refers to a network entity 656 implemented in a substrate network. As used herein, the term “substrate network” refers to a physical network infrastructure. The substrate network generally provides a foundation of a virtual cloud network. The substrate network may include physical network devices, such as routers, switches, network links, and other networking components. The substrate network may generally provide the basic connectivity and transport capabilities necessary for data transmission within and between data centers.

The one or more substrate entities may include substrate hosts, routers, firewall appliances, load balancers, storage devices, and/or substrate services. A substrate host may include an endpoint within the substrate network, such as a bare metal host, a virtual machine, a container, or a physical server. A substrate service may include a service executing or executable on a substrate entity, such as a firmware service, a network connectivity service, an addressing service, a name resolution service, a security service, a network monitoring service, a load balancing service, and/or a storage service. A firmware service may be associated with functionality or management of network infrastructure components or services, such as network devices, boot-up or initialization process, hardware controls, feature enablement, updates, hardware abstraction, network configuration, and/or network management. In one example, a substrate entity may include a combination of hardware and software. In one example, the one or more substrate entities may include one or more substrate hosts, and/or one or more substrate services. In one example, a substrate host may include a bare metal host. In one example, a substrate service may include a firmware service. The substrate entities may communicate with one another, and/or with other network entities 656, using logical network addresses assigned within the overlay network.

As used herein, the term “network interface” refers to a communication interface between a substrate network and an overlay network, such as a network interface card, a smartNIC, or the like. A network interface may include one or more interface entities, such as a node on the network interface, or an interface service executing or executable on the network interface. A node on the network interface may include a programmable hardware component, a memory component, or a gateway component. In one example, a network interface may include a network interface card, such as a smartNIC. Additionally, or in the alternative, a network interface may include a node or an endpoint on a network interface card or smartNIC.

A gateway component may provide connectivity between the substrate network and the network interface, and/or between the network interface and the overlay network. For example, a gateway component may enable communication between overlay entities and substrate entities. Additionally, or in the alternative, a gateway component may provide connectivity between the overlay network and external networks, such as the internet or other networks outside the overlay network. For example, an overlay gateway may enable communication between overlay entities and external endpoints.

As used herein, the term “overlay network” refers to a virtual network built on a substrate network using software-defined networking (SDN), virtualization, tunneling, and/or encapsulation technologies. An overlay network generally operates independently of the underlying substrate network. An overlay network may provide logical separation and isolation of traffic, enable virtual network provisioning, and/or allow for implementation of various network services and policies. Virtual machines, hosts, containers, or virtual network functions running on a substrate network may be connected via an overlay network.

As used herein, the term “overlay entity” refers to a network entity implemented on an overlay network. The overlay network may include a plurality of overlay entities. The plurality of overlay entities may include overlay hosts, overlay services, subnets, overlay controllers, and/or overlay clients. In one example, the overlay network may include a plurality of overlay entities. In one example, an overlay entity may include an overlay host. Additionally, or in the alternative, an overlay entity may include an overlay service. The plurality of overlay entities may communicate with one another using logical network addresses assigned within the overlay network.

An overlay host may include an endpoint within the overlay network, such as a virtual machine, a container, or a physical server. An overlay service may include a service executing or executable on an overlay entity. An overlay service may include a client-specific service, such as a service installed by a client. Additionally, or in the alternative, an overlay service may include a virtual network creation service, a virtual network management service, a virtual machine orchestration service, a container orchestration service, a network virtualization service, an overlay security service, a load balancing service, a multi-tenancy service, and/or a tenant isolation service.

A subnet may include a virtual network segment that has a distinct addressing scheme and/or a distinct set of network policies and/or services. A subnet may include a set of overlay hosts. Multiple subnets may be utilized to partition respective sets of overlay hosts. An overlay controller may oversee management, control, provisioning, configuration, and/or monitoring of an overlay network, network entities on the overlay network, and/or network policies within the overlay. An overlay controller interact with the underlying substrate network, for example, to coordinate the operation of overlay hosts and/or communications across virtual switches and tunnels. An overlay client may include an endpoint or device that initiates communication within the overlay network. An overlay client may be a specific instance or role within an overlay host. An overlay host may include a set of overlay clients. An overlay client may include a consumer or user of services provided by overlay hosts or the IaaS. An overlay client may request and consume resources or services from overlay hosts, acting as consumers or clients of those resources or services.

The plurality of network entities 656 may include a plurality of data repositories. Each of the data repositories may include any type of storage unit and/or device (e.g., a file system, database, collection of tables, or any other storage mechanism) for storing data. Further, a data repository may include multiple different storage units and/or devices. The multiple different storage units and/or devices may or may not be of the same type or located at the same physical site. The data repositories may share one or more storage units with one another. Additionally, or in the alternative, the data repositories may include one or more storage units that differ from one another. Further, one or more of the data repositories may be implemented or executed on the same computing system as virtual cloud network 602. Additionally, or in the alternative, one or more of the data repositories may be implemented or executed on a computing system separate from virtual cloud network 602.

In one or more embodiments, the system 600 may include more or fewer components than the components illustrated in FIGS. 6A and 6B. The components illustrated in FIGS. 6A and 6B may be local to or remote from each other. The components illustrated in FIGS. 6A and 6B may include software and/or hardware components. Each component may be distributed over multiple applications and/or machines. Multiple components may be combined into one application and/or machine. Operations described with respect to one component may instead be performed by another component. Additional embodiments and/or examples relating to the system 600 are described above in Section 2, titled “Cloud Computing Technology”.

In an embodiment, the system 600 may include various components implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 6. Pre-Approval, Approval, and Access Operations

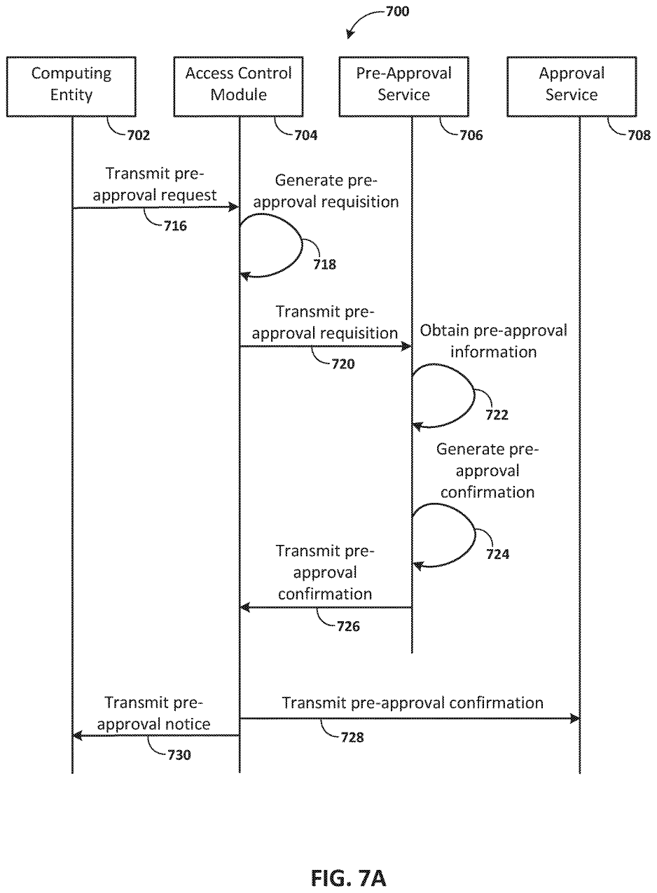

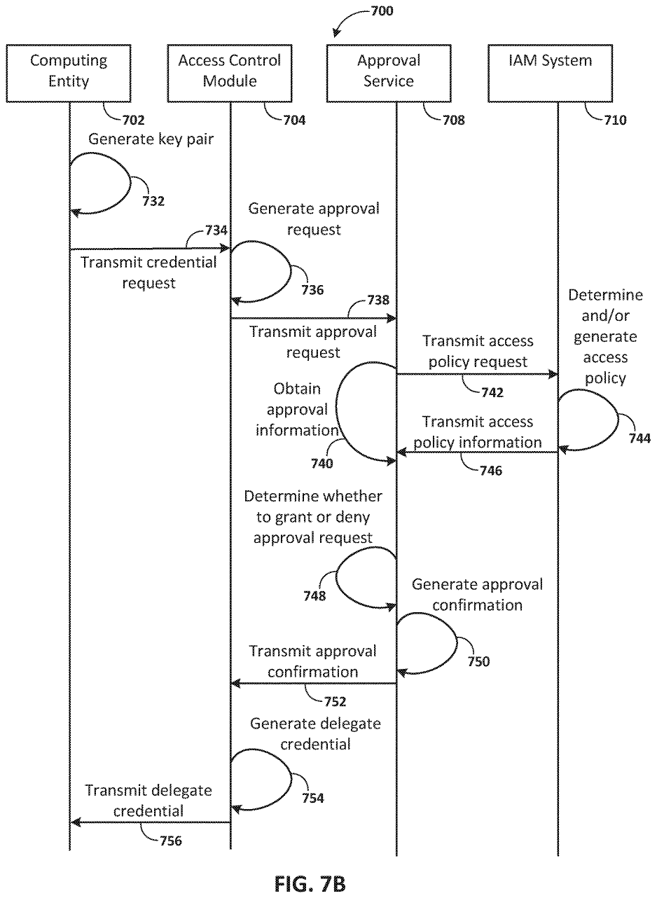

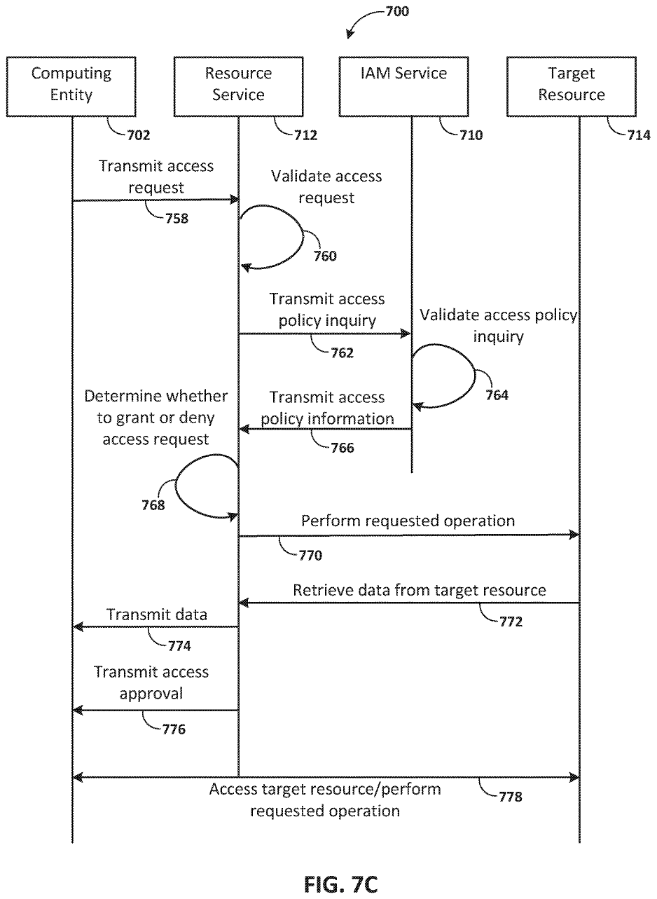

Referring now to FIGS. 7A-7C, operations 700 are further described pertaining to pre-approval (FIG. 7A) approval (FIG. 7B) to obtain delegate credentials, issuance of delegate credentials (FIG. 7B), and use of delegate credentials to access target resources (FIG. 7C). One or more operations 700 described with reference to in FIGS. 7A-7C may be modified, combined, rearranged, or omitted all together. Accordingly, the particular sequence of operations 700 described with reference to FIGS. 7A-7C should not be construed as limiting the scope of one or more embodiments. As shown in FIG. 7A, the operations 700 may include operations performed by and/or associated with one or more of: a computing entity 702, an access control module 704, a pre-approval service 706, and/or an approval service 708. As shown in FIG. 7B, the operations 700 may include operations performed by and/or associated with one or more of: the computing entity 702, the access control module 704, the approval service 708, and/or an IAM system 710. As shown in FIG. 7C, the operations 700 may include operations performed by and/or associated with one or more of: the computing entity 702, a resource service 712, the IAM system 710, and/or a target resource 714. In one example, the operations 700 may be performed by the one or more components of the system described with reference to FIGS. 6A and 6B.

### A. Pre-Approving Requests to Access Target Resources

Referring to FIG. 7A, operations 700 pertaining to pre-approving requests to access target resources are further described. As shown in FIG. 7A, a computing entity 702 may transmit a pre-approval request to an access control module 704 (operation 716). The pre-approval request may include a request for pre-approval to obtain a delegate credential for accessing a target resource. The pre-approval request may be associated with a particular recipient principal to which the identity represented by the delegate principal would be delegated to enable computing entity associated with the recipient principal to access the target resource based on one or more access policies associated with the delegate principal. The access control module 704 may receive the pre-approval request associated with a recipient principal from the computing entity 702.

In one example, the pre-approval request may include information pertaining to the pre-approval being requested. The information pertaining to the pre-approval may include at least one of: a recipient principal-identifier that identifies the recipient principal associated with the pre-approval request; a target resource-identifier that identifies the target resource that would be accessed via the delegate credential; or a permission-identifier that identifies one or more access permissions for which pre-approval is being requested.

In one example, the pre-approval request may include an authentication credential associated with the computing entity and/or the recipient principal. The authentication credential may include at least one of: a token, a digital certificate, a digital signature, or a username. The authentication credential may be utilized to authenticate the computing entity and/or the recipient principal in connection with the pre-approval request. Upon receiving the pre-approval request, the access control module 704 may authenticate the pre-approval request based on the authentication credential (not shown). Additionally, or in the alternative, the access control module 704 may authenticate the computing entity and/or the recipient principal associated with the pre-approval request based on the authentication credential (not shown).

Responsive to receiving and/or successfully authenticating the pre-approval request, the access control module 704 may generate a pre-approval requisition (operation 718). The pre-approval requisition may include information from the pre-approval request, such as the recipient principal-identifier, the target resource-identifier, and/or the permission-identifier. In one example, the access control module 704 may add information to the pre-approval requisition that was not in the pre-approval request. For example, based on information in the pre-approval request and/or information pertaining to the recipient principal and/or the computing entity 608, the access control module 704 may identify the particular tenant, tenant compartment, and/or resource service corresponding to the target resource. All or a portion of the information determined by the access control module 704 may be included in the pre-approval requisition.

The access control module 704 may transmit the pre-approval requisition to a pre-approval service 706 (operation 720). In one example, prior to transmitting the pre-approval requisition to the pre-approval service 706, the access control module 704 may determine a particular pre-approval service 706, from a set of pre-approval services, to which the pre-approval requisition is to be transmitted. The particular pre-approval service 706 to which the pre-approval requisition is to be transmitted may be determined based on the tenant, the tenant compartment, and/or the target resource corresponding to the pre-approval requisition. In one example, each pre-approval service 706, of the set of pre-approval services, may respectively correspond to a particular tenant, a particular tenant compartment, and/or a particular set of one or more target resources. Additionally, or in the alternative, a particular pre-approval service 706 may be utilized for various pre-approval requisition corresponding to a plurality of different tenants, tenant compartments, and/or target resources.

The pre-approval service 706 may receive the pre-approval requisition from the access control module 704. In one example, the pre-approval requisition may include an access control module credential. The access control module credential may include at least one of: a token, a digital certificate, a digital signature, or a username. The access control module credential may be utilized to authenticate the access control module 704 in connection with the pre-approval requisition. Upon receiving the pre-approval requisition, the pre-approval service 706 may authenticate the pre-approval requisition and/or the access control module 704 based on the access control module credential (not shown).

Responsive to receiving and/or successfully authenticating the pre-approval requisition, the pre-approval service 706 may obtain pre-approval information (operation 722). The pre-approval service 706 may utilize the pre-approval information to determine whether to grant or deny the pre-approval requisition. In one example, the pre-approval service 706 may obtain the pre-approval information based at least in part on one or more automatic pre-approval operations. Additionally, or in the alternative, the pre-approval service 706 may obtain the pre-approval information based at least in part on one or more human-approval operations. Whether the pre-approval service 706 obtains the pre-approval information by way of on one or more automatic pre-approval operations and/or one or more human-approval operations may depend on at least one of: the tenant, the tenant compartment, and/or the target resource corresponding to the pre-approval requisition.

In one example, the pre-approval service 706 may obtain the pre-approval information based at least in part on one or more automatic pre-approval operations. The pre-approval service 706 may determine whether to grant or deny the pre-approval requisition based at least in part on information obtained from the one or more automatic pre-approval operations. The one or more automatic pre-approval operations may include determining whether information in the pre-approval requisition satisfies one or more pre-approval criteria. The one or more pre-approval criteria may include one or more criteria pertaining to at least one of: the recipient principal corresponding to the pre-approval requisition, or the computing entity corresponding to the pre-approval requisition. For example, pre-approval requisitions corresponding to one or more particular recipient principals and/or one or more particular computing entities may be automatically approved. Additionally, or in the alternative, the one or more pre-approval criteria may include one or more criteria pertaining to at least one of: the tenant, the tenant compartment, the target resource corresponding to the pre-approval requisition, or a time period or schedule for the access requested for pre-approval. For example, pre-approval requisitions corresponding to one or more particular tenants, one or more particular tenant compartments, and/or one or more particular target resources, may be automatically approved.

In one example, the pre-approval service 706 may obtain the pre-approval information based at least in part on one or more human-approval operations. The pre-approval service 706 may determine whether to grant or deny the pre-approval requisition based at least in part on information obtained from the one or more human-approval operations. The pre-approval service 706 may determine one or more human approvers and/or one or more contact destination for the one or more human approvers. A contact destination for a human approver may include at least one of: an email address, a text message number, a ticketing system address, a mobile application system address. The pre-approval service 706 may transmit one or more human approval requisitions to the one or more contact destinations. One or more human approvers may receive a human approval requisition and may provide a response. The pre-approval service 706 may receive a human approval confirmation from each of the one or more contact destinations in response to the one or more human approval requisitions. Each human approval confirmation may indicate whether the human approval requisition is approved or denied. The pre-approval service 706 may determine whether to grant or deny the pre-approval requisition based at least in part on whether the one or more human approval confirmation may indicate that the human approval requisition is approved or denied.

In one example, the pre-approval service 706 may approve the pre-approval request based on the pre-approval information. When the pre-approval request is approved, the pre-approval service 706 may generate a pre-approval confirmation (block 724). The pre-approval confirmation may indicate that the pre-approval request is approved. Additionally, or in the alternative, the pre-approval confirmation may indicate that the recipient principal is pre-approved for issuance of a delegate credential. The pre-approval confirmation may include pre-approval information that may be used by the approval service 708 in subsequent operations. In one example, the pre-approval confirmation may indicate that the pre-approval request is approved with respect to the target resource for the one or more access permissions requested in the pre-approval request. Additionally, or in the alternative, the pre-approval confirmation may indicate that the pre-approval request is approved for a more restrictive set of permissions than the one or more access permissions requested in the pre-approval request.

The pre-approval service 706 may transmit the approval confirmation to the access control module 704 (operation 726). Alternatively, if the pre-approval request is rejected, the pre-approval service 706 may generate a pre-approval rejection and transmit the pre-approval rejection to the access control module 704. The access control module 704 may receive the pre-approval confirmation from the pre-approval service 706. In response to receiving the pre-approval confirmation, the access control module 704 may transmit the pre-approval confirmation to an approval service 708 (operation 728). Additionally, or in the alternative, the access control module 704 may transmit a pre-approval notice to the computing entity 702 (operation 730). The pre-approval notice may include a pre-approval-identifier that may be utilized to identify information pertaining to the pre-approval in an approval data corpus.

In one example, prior to transmitting the pre-approval confirmation to the approval service 708, the access control module 704 may determine a particular approval service 708, from a set of approval services, to which the pre-approval confirmation is to be transmitted. The particular approval service 708 to which the pre-approval confirmation is to be transmitted may be determined based on the tenant, the tenant compartment, and/or the target resource corresponding to the pre-approval confirmation. In one example, each approval service 708, of the set of approval services, may respectively correspond to a particular tenant, a particular tenant compartment, and/or a particular set of one or more target resources. Additionally, or in the alternative, a particular approval service 708 may be utilized for a plurality of different tenants, tenant compartments, and/or target resources.

The approval service 708 may receive the pre-approval confirmation from the access control module 704. The pre-approval confirmation may include pre-approval information. The pre-approval information may include information from the pre-approval request and/or information from the pre-approval requisition. In one example, the pre-approval information may include at least one of: an indication of the recipient principal that is pre-approved, an indication of one or more target resources for which the recipient principal is pre-approved, and/or an indication of one or more permissions for which the recipient principal is pre-approved with respect to the target resource. In response to receiving the pre-approval confirmation, the approval service 708 may store the pre-approval information in the approval data corpus.

The computing entity 702 may receive the pre-approval notice from the access control module 704. In one example, the pre-approval notice may include a delegate credential for accessing the target resource 714 corresponding to the pre-approval. Additionally, or alternatively, in response to receiving the pre-approval notice, the computing entity 702 may initiate one or more operations 700 pertaining to requesting a delegate credential for accessing the target resource 714 corresponding to the pre-approval.

### B. Approval of Credential Requests and Issuance of Delegate Credentials

Referring to FIG. 7B, further described are operations 700 pertaining to approving requests for a delegate credential to access target resources, and generation and issuance of delegate credentials. One or more operations 700 described with reference to FIG. 7B may be performed to provision a recipient principal with a delegate credential for accessing a target resource based on one or more access policies associated with an identity represented by a delegate principal.

As shown in FIG. 7B, a computing entity 702 may generate a key pair to be associated with a delegate credential (operation 732). The key pair may include a public key and a private key. The public key may be incorporated into the delegate credential and the private key may be utilized to digitally sign access requests when utilizing the delegate credential to access a target resource 714. To obtain a delegate credential, the computing entity 702 may transmit a credential request to an access control module 704 (operation 734).

The credential request may include a request to obtain a delegate credential for accessing a target resource. The credential request may be associated with a particular recipient principal to which the identity represented by the delegate principal would be delegated to enable the computing entity associated with the recipient principal to access the target resource based on one or more access policies associated with the delegate principal. The access control module 704 may receive the credential request associated with a recipient principal from the computing entity 702.

In one example, credential request may include information pertaining to the delegate credential being requested. The information included in the credential request may include at least one of: a recipient principal-identifier that identifies the recipient principal associated with the credential request; a target resource-identifier that identifies the target resource that would be accessed via the delegate credential; or a permission-identifier that identifies one or more access permissions for which delegate credential is being requested. Additionally, or in the alternative, the information included in the credential request may include information from a pre-approval notice. The information from the pre-approval notice may include a pre-approval-identifier that identifies a pre-approval corresponding to the credential request. The pre-approval-identifier may be utilized to identify information pertaining to the pre-approval in an approval data corpus.

In one example, the credential request may include an authentication credential associated with the computing entity and/or the recipient principal. The authentication credential may include at least one of: token, a digital certificate, or a digital signature. The authentication credential may be utilized to authenticate the computing entity and/or the recipient principal in connection with the credential request. Upon receiving the credential request, the access control module 704 may authenticate the credential request based on the authentication credential (not shown). Additionally, or in the alternative, the access control module 704 may authenticate the computing entity and/or the recipient principal associated with the credential request based on the authentication credential (not shown).

Responsive to receiving and/or successfully authenticating the credential request, the access control module 704 may generate an approval request (operation 736). The approval request may include information from the credential request, such as the pre-approval-identifier, the recipient principal-identifier, the target resource-identifier, and/or the permission-identifier. In one example, the access control module 704 may add information to the approval request that was not in the pre-approval request. For example, based on information in the approval request and/or information pertaining to the recipient principal and/or the computing entity 608, the access control module 704 may identify the particular tenant, tenant compartment, and/or resource service corresponding to the target resource. All or a portion of the information determined by the access control module 704 may be included in the approval request.

The access control module 704 may transmit the approval request to an approval service 708 (operation 738). In one example, prior to transmitting the approval request to the approval service 708, the access control module 704 may determine a particular approval service 708, from a set of approval services, to which the approval request is to be transmitted. The particular approval service 708 to which the approval request is to be transmitted may be determined based on the tenant, the tenant compartment, and/or the target resource corresponding to the approval request. In one example, each approval service 708, of the set of pre-approval services, may respectively correspond to a particular tenant, a particular tenant compartment, and/or a particular set of one or more target resources. Additionally, or in the alternative, a particular approval service 708 may be utilized for various approval requests corresponding to a plurality of different tenants, tenant compartments, and/or target resources.

The approval service 708 may receive the approval request from the access control module 704. In one example, the approval request may include an access control module credential. The access control module credential may include at least one of: token, a digital certificate, or a digital signature. The access control module credential may be utilized to authenticate the access control module 704 in connection with the approval request. Upon receiving the approval request, the approval service 708 may authenticate the approval request and/or the access control module 704 based on the access control module credential (not shown).

Responsive to receiving and/or successfully authenticating the approval request, the approval service 708 may obtain approval information (operation 740). The approval information may include information from the approval data corpus. The approval information may include information pertaining to a pre-approval associated with the recipient principal. Additionally, or in the alternative, the approval information may include information from the IAM system 710.

In one example, responsive to receiving and/or successfully authenticating the approval request, the approval service 708 may transmit an access policy request to the IAM system 710 (operation 742). The access policy request may include a request for the IAM system 710 to determine whether the IAM system 710 includes an access policy corresponding to the approval request. Additionally, or in the alternative, the access policy request may include a request for the IAM system 710 to generate an access policy corresponding to the approval request, for example, in the event that the IAM system 710 does not already include an access policy corresponding to the approval request. The access policy request may include information for the IAM system 710 to determine whether the IAM system includes an access policy corresponding to the approval request and/or to generate an access policy corresponding to the approval request.

The IAM system 710 may receive the access policy request. In response to receiving the access policy request, the IAM system 710 may determine and/or generate an access policy corresponding to the access policy request (operation 744). The IAM system 710 may transmit access policy information to the approval service (operation 746). The access policy information may include an indication as to whether the IAM system includes an access policy corresponding to the access policy request. Additionally, or in the alternative, the access policy information may include information for identifying one or more access policies in the IAM system.

In one example, the IAM system 710 may include one or more criteria for generating an access policy. The one or more criteria may include a requirement that a pre-approval has been obtained that corresponds to the approval request. The access policy request may include the pre-approval confirmation. The IAM system 710 may utilize the information in the pre-approval confirmation to determine whether generation of the access policy according to the access policy request is pre-approved. Additionally, or in the alternative, the IAM system 710 may query the approval data corpus for information to determine whether generation of the access policy according to the access policy request is pre-approved.

In one example, the access policy information may include a delegate principal-identifier. The delegate principal-identifier may be utilized to identify the delegate principal in the IAM system 710 and, based on the delegate principal, corresponding access policies and/or target resources. The delegate principal-identifier may identify a delegate principal in the IAM system 710. The IAM system 710 may select the delegate principal-identifier from a set of delegate principals available in the IAM system 710. Additionally, or in the alternative, the delegate principal-identifier in the IAM system 710 may be unique to the particular delegate principal to be delegated to the recipient principal. In one example, the access policy information may include an indication that the IAM system does not include an access policy corresponding to the access policy request, when the access policy request includes a request for an access policy that is not pre-approved and/or that the IAM system is not authorized to generate.

In one example, the IAM system 710 may be pre-configured with a set of one or more delegate principal-identifiers. Each delegate principal-identifier may correspond to a set of one or more access policies respectively corresponding one or more target resources. Additionally, or in the alternative, the IAM system 710 may be configured with a delegate principal-identifier and a corresponding set of one or more access policies in response to an access policy configuration request.

Based on the approval information, such as information from the approval data corpus and/or information from the IAM system 710, the approval service 708 may determine whether to grant or deny the approval request (operation 748). The determination as to whether to grant or deny the approval request may be based on one or more approval criteria. In one example, the approval service 708 may determine whether pre-approval is required, and when pre-approval is required, the approval service 708 may determine whether pre-approval has been obtained for issuance of a delegate credential as requested in the approval request. The approval service 708 may determine whether the recipient principal is pre-approved with respect to the target resource and/or the permissions requested in the approval request. When the approval service 708 determines that a recipient principal is not pre-approved, the approval service 708 may initiate a pre-approval process and/or the approval service 708 may prompt the access control module 704 to initiate the pre-approval process. Additionally, or in the alternative, the approval service 708 may determine whether the information in the approval request matches the approval information. In one example, the approval service 708 may determine at least one of: whether the recipient in the approval request matches a recipient principal in the approval information; whether the target resource in the approval request matches a target resource in the approval information; or whether the access permission in the approval request matches an access permission in the approval information.

In one example, the approval service 708 may grant the approval request when the information in the approval request matches the approval information. Additionally, or in the alternative, the approval service 708 may deny the approval request when the information in the approval request does not match the approval information. In one example, if a permission requested in the approval request does not match the approval information, the approval service may grant the approval request based on one or more different or additional permissions.

In one example, the approval service 708 may grant the approval request based at least in part on one or more automatic pre-approval operations. The one or more automatic approval operations may include determining whether information in the approval request satisfies one or more approval criteria. The one or more approval criteria may include one or more criteria pertaining to at least one of: the recipient principal corresponding to the approval request, or the computing entity corresponding to the approval requisition. For example, approval requests corresponding to one or more particular recipient principals and/or one or more particular computing entities may be automatically approved. Additionally, or in the alternative, the one or more approval criteria may include one or more criteria pertaining to at least one of: the tenant, the tenant compartment, and/or the target resource corresponding to the pre-approval requisition. For example, approval requests corresponding to one or more particular tenants, one or more particular tenant compartments, and/or one or more particular target resources, may be automatically approved.

In one example, the approval service 708 may determine, based on the access policy information, whether the IAM system 710 is configured for delegation of the delegate principal to the recipient principal. If the IAM system 710 is not configured for delegation of the delegate principal to the recipient principal, the approval service 708 may transmit an access policy configuration request to IAM system 710, for example, as part of operation 742. The access policy configuration request may include information for the IAM system 710 to configure one or more access policies associated with the delegate principal to be delegated to the recipient principal. In one example, the access policy configuration request may include an indication of one or more access permissions and an indicator of one or more target resources corresponding to the access permissions. In response to receiving an access policy configuration request, the IAM system 710 may generate one or more access policies corresponding to the one or more access permissions and the one or more target resources in the access policy configuration request. The one or more access policies may be associated with one or more compartments corresponding to the target resource. Additionally, the IAM system 710 may generate a delegate principal associated with the one or more access policies, and a delegate principal-identifier and associate the delegate principal.

When the IAM system 710 is configured with the one or more access policies (e.g., when the IAM system 710 is already configured with the one or more access policies and/or when the IAM system 710 is configured with the one or more access policies in response to the access policy configuration request), the IAM system 710 may transmit an access policy confirmation to the approval service 708. The access policy confirmation may be included in the access policy information transmitted to the approval service 708 at operation 746. The access policy confirmation may indicate that the IAM system 710 is configured with one or more access policies corresponding to the delegate principal to be delegated to the recipient principal in accordance with the approval request.

Upon having determined to grant the approval request, the approval service 708 may generate an approval confirmation (operation 750) and may transmit the approval conformation to the access control module 704 (operation 752). The approval confirmation may indicate that the access control module 704 is approved to generate and issue a delegate credential in response to the credential request received by the access control module 704 at operation 734. The approval confirmation may include a delegate principal-identifier to be included in the delegate credential. In one example, generating the approval confirmation may include determining a delegate principal-identifier from the access policy information and including the delegate principal-identifier in the approval confirmation.

The access control module 704 may receive the approval conformation. In response to receiving the approval conformation, the access control module 704 may generate a delegate credential (operation 754), and the access control module 704 may transmit the delegate credential to the computing entity 702 (operation 756). The delegate credential may include the delegate principal-identifier from the approval conformation. Additionally, the delegate credential may include a public key associated with the recipient principal and/or the computing entity 702. In one example, the delegate credential may include the public key generated at operation 732 and transmitted to the access control module at operation 734. Alternatively, the access control module may generate a key pair and may include the public key of the key pair in the delegate credential and transmit the private key to the computing entity 702. The delegate credential may further include a target resource-identifier and/or a recipient principal-identifier. The target resource-identifier and/or the recipient principal-identifier may be determined based on the credential request.

### C. Accessing Target Resources

Referring further to FIG. 7C, further described are operations 700 pertaining to accessing a target resource based on one or more access policies associated with a delegate principal. In one example, once the computing entity 702 has received the delegate credential, the computing entity 702 may use the delegate credential to access the target resource 714. The computing entity 702 may request an operation that is permitted in accordance with the delegate credential, the resource service 712 may automatically validate the request, and provided that the request is valid (e.g., the delegate credential is valid and the requested operation is authorized), the requested operation may be executed without an additional call from the computing entity 702. FIG. 7C provides one non-limiting example set of operations 700 pertaining to accessing a target resource based on one or more access policies associated with a delegate principal. As shown in FIG. 7C, in one example, to access a target resource 714, a computing entity 702 may transmit an access request to a resource service 712 (operation 758). The access request may include a requested operation to be performed with respect to the target resource 714. The access request may include a delegate credential. Additionally, the access request may include a recipient credential. The requested operation to be performed with respect to the target resource 714 may be included in the delegate credential or may be identifiable based on, the delegate credential. Additionally, or alternatively, the requested operation may be included in the access request or may be identifiable based on the access request. The access request and/or the delegate credential may include a digital signature. The digital signature may be generated by digitally signing the access request and/or the delegate credential using a private key associated with the computing entity 702 and/or the recipient principal. A public key corresponding to the private key utilized to generate the digital signature may be included in the recipient credential and/or in the delegate credential.

The resource service 712 may receive the access request. In one example, in response to receiving the access request, the resource service may validate the access request (operation 760). The resource service 712 may validate the access request at least by authenticating the digital signature against the public key included in the recipient credential or in the delegate credential. Additionally, or alternatively, the resource service 712 may validate the access request at least by validating a recipient principal-identifier in the recipient credential against a recipient principal-identifier in the delegate credential. In response to validating the access request, the resource service 712 may transmit an access policy inquiry to the IAM system 710 (operation 762). The access policy inquiry may include information from the access request and/or information from the delegate credential. In one example, the access policy inquiry may include a delegate-principal identifier. Additionally, or in the alternative, the access policy inquiry may include a target resource-identifier and/or a recipient principal-identifier. The information in the access policy inquiry may include information for determining whether the IAM system 710 includes an access policy associated with a delegate principal that allows the computing entity 704 to access to the target resource to perform the requested operation.

The IAM system 710 may receive the access policy inquiry. In response to receiving the access policy inquiry, the IAM system 710 may validate the access policy inquiry (operation 764). The IAM system 710 may validate the access policy inquiry at least by determining whether the delegate-principal identifier in the access policy inquiry matches information in an access policy data corpus. Additionally, or in the alternative, the IAM system 710 may validate the access policy inquiry at least by determining whether a target resource-identifier and/or a recipient principal-identifier in the access policy inquiry matches information in the access policy data corpus.

Upon having validated the access policy inquiry, the IAM system 710 may transmit access policy information to the resource service 712 (operation 766). The access policy information may include an indication that the information in the access policy inquiry is valid. In one example, the access policy information may include an indication that the delegate-principal identifier in the access policy inquiry matches information in the access policy data corpus. Additionally, or in the alternative, the access policy information may include an indication that the target resource-identifier and/or the recipient principal-identifier in the access policy inquiry matches information in the access policy data corpus. Additionally, or in the alternative, the access policy information may include information from the access policy data corpus that the resource service 712 may utilize to determine whether to grant or deny the access request to perform the requested operation.

The resource service 712 may receive the access policy information. In response to receiving the access policy information, the resource service 712 may determine whether to grant or deny the access request (operation 768). The determination as to whether to grant or deny the access request may be based at least in part on the access policy information. In one example, the resource service 712 may determine whether to grant or deny the access request at least by comparing information in the access request to the access policy information. The resource service 712 may grant the access request when the information in the access request matches or corresponds to the access policy information. In one example, the resource service 712 may grant the access request when the requested operation is within the scope of operations that the access policy information indicates as being authorized. Additionally, or in the alternative, the resource service 712 may deny the access request when the information in the access request differs from the access policy information. In one example, the resource service 712 may deny the access request when the requested operation is outside the scope of operations that the access policy information indicates as being authorized. Alternatively, in one example, the information for determining whether to grant or deny the access request at operation 768 may be included in the access request and/or in the delegate credential, in which case the resource service 712 need not perform operations 760-766.

Upon having granted the access request, in one example, the resource service 712 may access the target resource 714 and may execute one or more operations in accordance with the approved access (operation 770), for example, on behalf of the computing entity 702. In one example, in connection with executing the approved operations, the resource service 712 may retrieve data from the target resource 714 (operation 772) and the resource service 712 may transmit the data to the computing entity 702 (operation 774). Additionally, or alternatively, the resource service 712 may transmit an access approval to the computing entity 702 (operation 776). In one example, the access approval may include an access token that may be utilized to access the target resource 714. Alternatively, the delegate credential may be utilized to access the target resource 714. The computing entity 702 may receive the access approval. In response to receiving the access approval, the computing entity 702 may access the target resource 714 (operation 778). The computing entity 702 may access the target resource 714 using the delegate credential and/or the access token provided via the access approval. When accessing the target resource 714, the computing entity 702 may transmit operations requested to be executed upon the target resource 714 to the resource service 712, and the resource service 712 may execute the operations. Additionally, or alternatively, the resource service 712 may transmit data obtained from the target resource 714 to the computing entity 702. Additionally, or alternatively, once authorized, the computing entity 702 may execute operations upon the target resource 714 directly, for example, without utilizing the resource service 712 as an intermediary. Additionally, or alternatively, once authorized, the computing entity 702 and the target resource 714 may exchange data directly with one another the computing entity 702 and, for example, without utilizing the resource service 712 as an intermediary. Alternatively, when the resource service 712 denies an access request, the resource service 712 may transmit an access denial to the computing entity 702.

### 7. Issuing Delegate Credentials to Recipient Principals

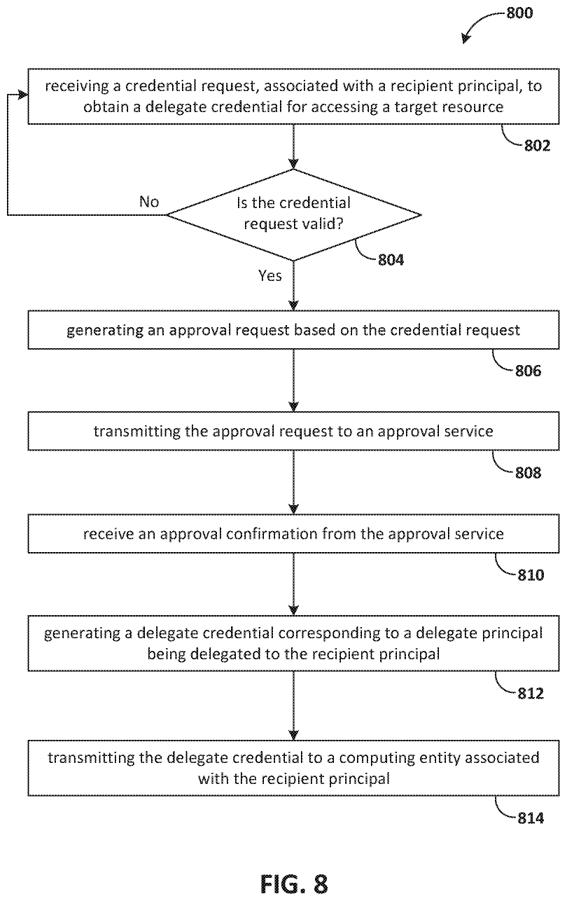

Referring now to FIG. 8, operations 800 pertaining to issuing delegate credentials to recipient principals are further described. One or more operations 800 described with reference to in FIG. 8 may be modified, combined, rearranged, or omitted all together. Accordingly, the particular sequence of operations 800 described with reference to FIG. 8 should not be construed as limiting the scope of one or more embodiments. In one example, the operations described with reference to FIG. 8 may include one or more operations 700 described with reference to FIGS. 7A-7C. In one example, the operations 800 may be performed by the one or more components of the system described with reference to FIGS. 6A and 6B.

As shown in FIG. 8, the operations 800 may include, at block 802, receiving a credential request, associated with a recipient principal, to obtain a delegate credential for accessing a target resource. The credential request may be received from a computing entity associated with the recipient principal. The credential request may include a request for a delegate credential to access a target resource based on one or more access policies associated with a delegate principal. The delegate principal may include an identity representation that is delegable to the recipient principal to enable the computing entity associated with the recipient principal to access the target resource based on the one or more access policies associated with the delegate principal. The credential request may further include a recipient principal-identifier that identifies the recipient principal, and a target resource-identifier that identifies the target resource. The recipient principal may be a user principal that represents an identity of a particular user. The delegate credential may be associated with the particular recipient principal, such as the particular user principal, such that the delegate credential may be utilized only in connection with the particular recipient principal, such as the particular user principal.

At block 804, the operations 800 may include determining whether the credential request valid. When the credential request is determined valid, at block 804, the operations 800 may proceed to block 806. When the credential request is determined invalid, the operations 800 may return to block 802.

In one example, the delegate credential may include a public key that corresponds to a private key associated with the recipient principal. The access request may include a digital signature generated by the private key, and the resource service may perform a validation of the digital signature against the public key. The validation may indicate that the digital signature corresponds to the public key, and the resource service may authorize the computing entity to access the target resource based on the validation indicating that the digital signature corresponds to the public key.

In one example, the resource service may determine that the one or more access policies associated with the delegate principal include a permission to access the target resource. The resource service may authorize the computing entity to access the target resource based on having determined that the one or more access policies associated with the delegate principal include the permission to access the target resource.

In one example, the one or more access policies may include a first access policy that includes a first permission to access a first compartment. The first compartment may include a first set of one or more logical containers, and the target resource may be located within the first set of one or more logical containers. Additionally, or in the alternative, the one or more access policies may include a second access policy that includes a second permission to access a second compartment. The second compartment may include a second set of one or more logical containers associated with a tenant of a cloud infrastructure. The second set of one or more logical containers may include the first set of one or more logical containers, and the target resource may be provisioned by the tenant in the first set of one or more logical containers. Additionally, or in the alternative, the one or more access policies may include a third access policy that includes a third permission to access a third compartment. The third compartment may include a third set of one or more logical containers associated with a cloud provider. The third set of one or more logical containers may include the second set of one or more logical containers, and the cloud infrastructure may be provisioned by the cloud provider in the second set of one or more logical containers.

At block 806, the operations 800 may include generating an approval request based on the credential request. The approval request may include the recipient principal-identifier and the target resource-identifier. At block 808, the operations 800 may include transmitting the approval request to an approval service. In one example, the approval service receives the approval request, and the approval service determines that the approval request meets one or more approval criteria. The one or more approval criteria may include at least one of: the recipient principal is pre-approved to obtain the delegate credential, the recipient principal-identifier matches a first data item in an approval data corpus, or the target resource-identifier matches a second data item in the approval data corpus. The approval service may grant the approval request responsive to determining that the approval request meets the one or more approval criteria.

In one example, the approval service may configure the IAM system to include the one or more access policies associated with the delegate principal. Additionally, or in the alternative, the approval service may determine that the IAM system includes the one or more access policies associated with the delegate principal. The approval service may generate the approval confirmation, for example, responsive to determining that the approval request meets the one or more approval criteria and/or responsive to configuring the IAM system to include the one or more access policies and/or determining that the IAM system already includes the one or more access policies.

In one example, the approval service may generate an access policy request that includes a request for the IAM system to generate the one or more access policies associated with the delegate credential. The approval service may transmit the access policy request to the IAM system, and the IAM system may generate the one or more access policies. Additionally, or in the alternative, the IAM system may associate the delegate principal-identifier with the one or more access policies. The IAM system may generate an access policy confirmation, and the IAM system may transmit the access policy confirmation to the approval service. The approval service may receive the access policy confirmation, and the approval service may generate the approval confirmation subsequent to receiving the access policy confirmation.

At block 810, the operations 800 may include receive an approval confirmation from the approval service. The approval service may approve the approval request based at least on the recipient principal-identifier and the target resource-identifier. The approval confirmation may include a delegate principal-identifier. The one or more access policies associated with the delegate principal may be identifiable in an IAM system based at least in part on the delegate principal-identifier. At block 812, the operations 800 may include generating a delegate credential corresponding to a delegate principal being delegated to the recipient principal. The delegate credential may be generated responsive to receiving the approval confirmation. The delegate credential may include the delegate principal-identifier. At block 814, the operations 800 may include transmitting the delegate credential to a computing entity associated with the recipient principal.

The computing entity associated with the recipient principal may accesses the target resource based on the identity representation of the delegate principal at least by presenting to a resource service associated with the target resource, the delegate credential and an access request to access the target resource. The resource service may authorize the computing entity to access the target resource based on the one or more access policies associated with the delegate principal. The resource service may identify the one or more access policies in the IAM system based on the delegate principal-identifier. In one example, the resource service may authorize the computing entity to access the target resource based on successfully validating that the recipient principal-identifier of the delegate credential corresponds to the recipient principal utilizing the computing entity.

In one example, prior to receiving the credential request, the operations 800 may include receiving, from the computing entity, a pre-approval request associated with the recipient principal. The pre-approval request may include the recipient principal-identifier, the target resource-identifier, and a permission-identifier. The permission-identifier may identify one or more access permissions for delegation to the recipient principal with respect to the target resource. The operations 800 may further include generating a pre-approval requisition based on the pre-approval request. The pre-approval requisition may include the recipient principal-identifier, the target resource-identifier, and the permission-identifier. The operations 800 may further include transmitting the pre-approval requisition to a pre-approval service.

In one example, the pre-approval service may receive the pre-approval requisition, and the pre-approval service may determine, based on the pre-approval requisition, a contact destination associated with a human approver. The pre-approval service may transmit a human-approval requisition to the contact destination, and the pre-approval service may receive, from the contact destination, a human-approval confirmation. The pre-approval service may generate the pre-approval confirmation subsequent to receiving the human-approval confirmation. Additionally, or in the alternative, the pre-approval service may determine, based on the pre-approval requisition, that one or more pre-approval criteria are satisfied. The one or more pre-approval criteria may be based on at least one of: the recipient principal-identifier, the target resource-identifier, or the permission-identifier. The pre-approval service may generate the pre-approval confirmation responsive to determining that the one or more pre-approval criteria are satisfied.

The operations 800 may further include receiving a pre-approval confirmation from the pre-approval service. The pre-approval confirmation may include pre-approval information indicating that the recipient principal is pre-approved for delegation of the one or more access permissions with respect to the target resource. The operations 800 may further include transmitting the pre-approval confirmation or the pre-approval information to the approval service, and the approval service may store the pre-approval confirmation or the pre-approval information in an approval data corpus. In one example, subsequent to receiving the pre-approval confirmation from the pre-approval service, the operations 800 may further include transmitting a pre-approval notice to the computing entity. The computing entity may receive the pre-approval notice, and the computing entity may transmit the credential request subsequent to receiving the pre-approval notice.

### 8. Miscellaneous; Extensions

Embodiments are directed to a system with one or more devices that include a hardware processor and that are configured to perform any of the operations described herein and/or recited in any of the claims below. Embodiments are directed to a system including means to perform any of the operations described herein and/or recited in any of the claims below. In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

All references, including publications, patent applications, and patents, cited herein are hereby incorporated by reference to the same extent as if each reference were individually and specifically indicated to be incorporated by reference and were set forth in its entirety herein.

What is claimed is:

1. A method, comprising:
receiving, from a first computing entity associated with a first recipient principal, a first credential request for a first delegate credential for the first recipient principal to access a first target resource,
determining a first set of one or more access permissions for the first recipient principal to access the first target resource;
determining that a plurality of access policies, associated with a delegate principal, in an access policy corpus do not include the first set of one or more access permissions;
responsive to determining that the plurality of access policies do not include do not include the first set of one or more access permissions:
generating, in association with the delegate principal, a first set of one or more access policies having a scope limited to the first set of one or more access permissions;
issuing the first delegate credential to the first recipient principal based on the first set of one or more access policies;
wherein the first computing entity associated with the first recipient principal utilizes the first delegate credential to access the first target resource;
wherein the method is performed by at least one device including a hardware processor.

2. The method of claim 1, wherein the first credential request comprises a first permission identifier that identifies the first set of one or more access permissions.

3. The method of claim 1, wherein determining the first set of one or more access permissions comprises:
identifying a first permission identifier associated with the first credential request, wherein the first permission identifier identifies the first set of one or more access permissions; and
determining, based on the first permission identifier, that the plurality of access policies do not include the first set of one or more access policies corresponding to the first set of one or more access permissions identified by the first permission identifier.

4. The method of claim 1, further comprising:
receiving, from a second computing entity associated with a second recipient principal, a second credential request for a second delegate credential to access a second target resource based on one or more access policies associated with the delegate principal,
wherein the second credential request comprises a second permission identifier that identifies a second set of one or more access permissions requested for accessing the second target resource,
wherein the second set of one or more access permissions differs in scope from the first set of one or more access permissions;
determining that the plurality of access policies in the access policy corpus include a second set of one or more access policies having a scope limited to the second set of one or more access permissions identified by the second permission identifier;
responsive to determining that the plurality of access policies include the second set of one or more access policies:
issuing the second delegate credential to the second recipient principal based on the second set of one or more access policies;
wherein the second computing entity associated with the second recipient principal utilizes the second delegate credential to access the second target resource.

5. The method of claim 1, further comprising:
receiving, from a second computing entity associated with a second recipient principal, a second credential request for a second delegate credential to access a second target resource based on one or more access policies associated with the delegate principal,
wherein the second credential request comprises a second permission identifier that identifies a second set of one or more access permissions requested for accessing the second target resource,
wherein the second set of one or more access permissions differs in scope from the first set of one or more access permissions;
determining that the plurality of access policies in the access policy corpus do not include a second set of one or more access policies corresponding to the second set of one or more access permissions identified by the second permission identifier;
responsive to determining that the plurality of access policies do not include the second set of one or more access policies corresponding to the second set of one or more access permissions identified by the second permission identifier:
generating, in association with the delegate principal, the second set of one or more access policies having a scope limited to the second set of one or more access permissions identified by the second permission identifier;
issuing the second delegate credential to the second recipient principal based on the second set of one or more access policies;
wherein the second computing entity associated with the second recipient principal utilizes the second delegate credential to access the second target resource.

6. The method of claim 1, wherein the first set of one or more access permissions comprises:
(a) an action permission that identifies one or more types of access that are allowed or denied, and
(b) a temporal permission that included one or more time-based condition on the action permission.

7. The method of claim 1,
wherein the first credential request comprises a delegate principal identifier;
wherein determining that the plurality of access policies in the access policy corpus do not include one or more access policies corresponding to the first set of one or more access permissions comprises:
identifying a second set of one or more access policies in the access policy corpus based at least in part on the delegate principal identifier, and
determining that the second set of one or more access policies are not limited to the first set of one or more access permissions.

8. The method of claim 1, wherein the first set of one or more access policies comprise at least one of:
a first access policy comprising a first permission to access a first compartment,
wherein the first compartment comprises a first set of one or more logical containers,
wherein the first target resource is located within the first set of one or more logical containers;
a second access policy comprising a second permission to access a second compartment,
wherein the second compartment comprises a second set of one or more logical containers associated with a tenant of a cloud infrastructure,
wherein the second set of one or more logical containers comprises the first set of one or more logical containers,
wherein the first target resource is provisioned by the tenant;
a third access policy comprising a third permission to access a third compartment,
wherein the third compartment comprises a third set of one or more logical containers associated with a cloud provider,
wherein the third set of one or more logical containers comprises the second set of one or more logical containers,
wherein the cloud infrastructure is provisioned by the cloud provider.

9. The method of claim 1, further comprising:
prior to issuing the first delegate credential:
generating an approval request, the approval request identifying the first recipient principal and the first target resource;
transmitting the approval request to an approval service;
receiving an approval confirmation in response to the approval request, wherein the approval confirmation comprises a delegate principal identifier, identifying the delegate principal, to be included in the first delegate credential;
issuing the first delegate credential based at least in part on the approval confirmation, wherein issuing the first delegate credential comprises:
adding a public key, of a key pair associated with the delegate principal, to the first delegate credential, and
digitally signing the first delegate credential using a private key of the key pair associated with the delegate principal.

10. One or more non-transitory computer-readable media storing instructions that, when executed by one or more hardware processors, cause performance of operations comprising:
receiving, from a first computing entity associated with a first recipient principal, a first credential request for a first delegate credential for the first recipient principal to access a first target resource,
determining a first set of one or more access permissions for the first recipient principal to access the first target resource;
determining that a plurality of access policies, associated with a delegate principal, in an access policy corpus do not include the first set of one or more access permissions;
responsive to determining that the plurality of access policies do not include do not include the first set of one or more access permissions:
generating, in association with the delegate principal, a first set of one or more access policies having a scope limited to the first set of one or more access permissions;
issuing the first delegate credential to the first recipient principal based on the first set of one or more access policies;
wherein the first computing entity associated with the first recipient principal utilizes the first delegate credential to access the first target resource.

11. The one or more non-transitory computer-readable media of claim 10, wherein the first credential request comprises a first permission identifier that identifies the first set of one or more access permissions.

12. The one or more non-transitory computer-readable media of claim 10, wherein determining the first set of one or more access permissions comprises:
identifying a first permission identifier associated with the first credential request, wherein the first permission identifier identifies the first set of one or more access permissions; and
determining, based on the first permission identifier, that the plurality of access policies do not include the first set of one or more access policies corresponding to the first set of one or more access permissions identified by the first permission identifier.

13. The one or more non-transitory computer-readable media of claim 10, wherein the operations further comprise:
receiving, from a second computing entity associated with a second recipient principal, a second credential request for a second delegate credential to access a second target resource based on one or more access policies associated with the delegate principal,
wherein the second credential request comprises a second permission identifier that identifies a second set of one or more access permissions requested for accessing the second target resource,
wherein the second set of one or more access permissions differs in scope from the first set of one or more access permissions;
determining that the plurality of access policies in the access policy corpus include a second set of one or more access policies having a scope limited to the second set of one or more access permissions identified by the second permission identifier;
responsive to determining that the plurality of access policies include the second set of one or more access policies:
issuing the second delegate credential to the second recipient principal based on the second set of one or more access policies;
wherein the second computing entity associated with the second recipient principal utilizes the second delegate credential to access the second target resource.

14. The one or more non-transitory computer-readable media of claim 10, wherein the operations further comprise:
receiving, from a second computing entity associated with a second recipient principal, a second credential request for a second delegate credential to access a second target resource based on one or more access policies associated with the delegate principal,
wherein the second credential request comprises a second permission identifier that identifies a second set of one or more access permissions requested for accessing the second target resource,
wherein the second set of one or more access permissions differs in scope from the first set of one or more access permissions;
determining that the plurality of access policies in the access policy corpus do not include a second set of one or more access policies corresponding to the second set of one or more access permissions identified by the second permission identifier;
responsive to determining that the plurality of access policies do not include the second set of one or more access policies corresponding to the second set of one or more access permissions identified by the second permission identifier:
generating, in association with the delegate principal, the second set of one or more access policies having a scope limited to the second set of one or more access permissions identified by the second permission identifier;
issuing the second delegate credential to the second recipient principal based on the second set of one or more access policies;
wherein the second computing entity associated with the second recipient principal utilizes the second delegate credential to access the second target resource.

15. The one or more non-transitory computer-readable media of claim 10, wherein the first set of one or more access permissions comprises:
(a) an action permission that identifies one or more types of access that are allowed or denied, and
(b) a temporal permission that included one or more time-based condition on the action permission.

16. The one or more non-transitory computer-readable media of claim 10,
wherein the first credential request comprises a delegate principal identifier;
wherein determining that the plurality of access policies in the access policy corpus do not include one or more access policies corresponding to the first set of one or more access permissions comprises:
identifying a second set of one or more access policies in the access policy corpus based at least in part on the delegate principal identifier, and
determining that the second set of one or more access policies are not limited to the first set of one or more access permissions.

17. The one or more non-transitory computer-readable media of claim 10, wherein the first set of one or more access policies comprise at least one of:
a first access policy comprising a first permission to access a first compartment,
wherein the first compartment comprises a first set of one or more logical containers,
wherein the first target resource is located within the first set of one or more logical containers;
a second access policy comprising a second permission to access a second compartment,
wherein the second compartment comprises a second set of one or more logical containers associated with a tenant of a cloud infrastructure,
wherein the second set of one or more logical containers comprises the first set of one or more logical containers,
wherein the first target resource is provisioned by the tenant;
a third access policy comprising a third permission to access a third compartment,
wherein the third compartment comprises a third set of one or more logical containers associated with a cloud provider,
wherein the third set of one or more logical containers comprises the second set of one or more logical containers,
wherein the cloud infrastructure is provisioned by the cloud provider.

18. The one or more non-transitory computer-readable media of claim 10, wherein the operations further comprise:
prior to issuing the first delegate credential:
generating an approval request, the approval request identifying the first recipient principal and the first target resource;
transmitting the approval request to an approval service;
receiving an approval confirmation in response to the approval request, wherein the approval confirmation comprises a delegate principal identifier, identifying the delegate principal, to be included in the first delegate credential;
issuing the first delegate credential based at least in part on the approval confirmation, wherein issuing the first delegate credential comprises:
adding a public key, of a key pair associated with the delegate principal, to the first delegate credential, and
digitally signing the first delegate credential using a private key of the key pair associated with the delegate principal.

19. A system comprising:
one or more hardware processors;
one or more non-transitory computer-readable media; and
program instructions stored on the one or more non-transitory computer-readable media that, when executed by the one or more hardware processors, cause the system to perform operations comprising:
receiving, from a first computing entity associated with a first recipient principal, a first credential request for a first delegate credential for the first recipient principal to access a first target resource,
determining a first set of one or more access permissions for the first recipient principal to access the first target resource;
determining that a plurality of access policies, associated with a delegate principal, in an access policy corpus do not include the first set of one or more access permissions;
responsive to determining that the plurality of access policies do not include do not include the first set of one or more access permissions:
generating, in association with the delegate principal, a first set of one or more access policies having a scope limited to the first set of one or more access permissions;
issuing the first delegate credential to the first recipient principal based on the first set of one or more access policies;
wherein the first computing entity associated with the first recipient principal utilizes the first delegate credential to access the first target resource.

20. The system of claim 19, wherein the first credential request comprises a first permission identifier that identifies the first set of one or more access permissions.
